(19) United States
(12) Patent Application Publication
(10) Pub. No.: US 2024/0183395 A1
(43) Pub. Date: Jun. 6, 2024

(54) BEARING-ASSEMBLY COMPONENT AND METHOD FOR MANUFACTURING SUCH A BEARING-ASSEMBLY COMPONENT

(71) Applicant: AKTIEBOLAGET SKF, GOTEBORG (SE)

(72) Inventor: Thilo VON SCHLEINITZ, Schweinfurt (DE)

(21) Appl. No.: 18/514,453

(22) Filed: Nov. 20, 2023

(30) Foreign Application Priority Data
Dec. 2, 2022 (DE) 102022213019.7

(51) Int. Cl. F16C 33/12; F16C 33/14

(52) U.S. Cl. CPC F16C 33/12; F16C 33/14; F16C 2223/02

(57) ABSTRACT

A first bearing assembly component, which is configured to be connected to a second bearing assembly component, has a contact surface configured to frictionally engage a counter-contact surface of the second bearing assembly component to secure the first bearing assembly component to the second bearing assembly component. The contact surface includes at least one embossed structure or embossed pattern. Also an assembly of the first and second bearing assembly components and a method of forming the first bearing assembly component.

### CROSS-REFERENCE

This application claims priority to German patent application no. 10 2022 213 019.7 filed on Dec. 2, 2022, the contents of which are fully incorporated herein by reference.

### TECHNOLOGICAL FIELD

The present disclosure is directed to a bearing-assembly component and a method for manufacturing a bearing-assembly component which component is configured to be connected to another bearing assembly component in a friction-fit manner.

### BACKGROUND

In bearing assemblies, it can be necessary to connect various components, such as, for example, a bearing ring to a shaft or a housing in a rotationally fixed and displacement-resistant manner. This can be effected in different ways.

For example, the inner ring can be press-fitted onto a shaft, or the inner ring can be heated so that it expands somewhat and is then shrunk onto the shaft as it cools. In such construction methods the range of acceptable pressures produced by the ring against the shaft is limited. On the one hand it must not overload the materials, and on the other hand it must still be possible to assemble. The thermal loadability of the heat-treated steel is also strictly limited. Occasionally it can occur, for example, in wind-power applications, that despite a friction-fit connecting of a ring of the rolling-element bearing or plain bearing to the surrounding construction (e.g., housing or shaft), a so-called ring migration occurs. The movement can occur as axial displacement or as slow rotation or as a combination of both. Here the affected ring shifts very slowly in its position. Such a ring migration is unwanted since it can adversely affect the correct positioning of the bearing and also cause damage such as fretting corrosion to the seat. Furthermore, a bearing may be intended for a specific mounting position, i.e., a ring may require a position that is either absolutely fixed or fixed relative to its surroundings (e.g., relative to a rotating shaft) due to connections, lubrication holes, or similar non-circularly symmetrical design features, and this position must not change after it has been established.

If a positive connection of the ring to the corresponding component is not possible by means of bolts, feather keys, axial pressure covers or similar elements, it may be necessary to use a frictional connection designed in such a way that a sufficiently large frictional force is produced, in particular, a frictional force which is sufficiently large to prevent the ring migration described above. In this context, the friction force is determined by the friction value, assuming a maximum normal force or contact pressure force.

Typically the friction between two components of a bearing assembly can be increased by increasing the friction value (also called friction coefficient or coefficient of friction) of at least one contact surface of the two components. A known solution for the friction increase is the application of layers of zinc. However, in spray processes, such as, for example, flame spraying, the layer accuracies are usually not sufficient to achieve a defined overlap and fit between, for example, the inner ring and shaft. A thus-required mechanical post-processing of the zinc surfaces is expensive and problematic due to the lubrication effect during the grinding. Since not the shaft but rather the ring is coated, with smaller rings it can also be difficult to carry out a spraying at the required nearly vertical angle to the surface of the bore. Furthermore, it is necessary to mask the remaining ring surfaces. The effort necessary for this purpose, which in addition to the masking includes sand blasting, spraying, and cleaning, is very high.

In galvanic zinc-plating methods, the ring is immersed in a bath, which can prove impossible in the case of large rolling-element bearings due to the workpiece size. Furthermore, functional surfaces such as the raceway must be extensively protected from chemical and electrolytic influence. In mechanical zinc-plating methods, there are also significant implementation problems in coating a large ring area by area.

A different known solution for increasing friction is the use of zinc lacquers or friction lacquers that can additionally contain particles of hard material. These also include coating methods in which zinc flakes are fixed on the surface with a lacquer-like binding agent. If such lacquers are used in immersion or spray methods, the above-described problems of the coating only needed in the bore of the inner ring, i.e., regionally, or of the workpiece size can occur. Although some lacquers can be applied in the bore of a ring without problems, they have a layer thickness tolerance of, for example, 35+10/−5 μm, i.e., 15 μm thickness fluctuation. However, for establishing a correct coverage and press fit, such a thickness fluctuation is too high. In addition, lacquer systems only very poorly tolerate the shear forces of a push on (press fitting one element onto the other).

Alternatively, instead of a press fit, the components can be adhered to each other. However, such an adhesive connection has the disadvantage that in the event of damage, it can be disassembled only with difficulty for the bearing exchange. There is also the risk that a thin liquid adhesive may reach unintended locations or even into the bearing interior.

A further possibility for increasing friction in order to connect two bearing assembly components to each other comprises a blasting of the ring bore. With sandblasting, or blasting with, for example, angular chilled cast iron or abrasive grain, the surface is roughened, and the friction thereby increased. Disadvantages are also associated with this method. Thus, it is actually undesirable to bring a rolling-element bearing ring into contact with blasting material since a hard grain that remains unnoticed on the ring can lead to progressive bearing damage if it finds its way in the interior and raceway contact of the finished rolling-element bearing. In addition, the blasting also requires a costly masking of the surfaces not to be processed. The blasting furthermore leads to material removal. This results in a decrease in the roundness and dimensional accuracy of the bore and possibly a critical change compared to the desired dimensional overlap and fit. Finally, the blasting is also effected in principle outside the fine processing or assembly areas and therefore requires a separate ring transport, possibly even to external cooperation partners. It is even possible that the blasting can decrease the friction forces instead of increasing them because, due to material removal and shape defects caused by the blasting, the normal forces may decrease such that micro-toothing and/or structures that contribute to a frictional engagement no longer engage as effectively with a counter-contact surface.

### SUMMARY

It is therefore an aspect of the present disclosure to provide a bearing-assembly component that is connectable to another bearing-assembly component in a positionally fixed manner in a reliable and simple manner.

In the following, “bearing assembly” is understood to mean any type of assembly of a bearing, such as a rolling-element bearing or plain bearing in a housing or on a shaft, but also a shaft-hub connection. Here a surface of a bearing-assembly component, such as, for example, an inner ring or outer ring of a bearing can have a contact surface in contact with a counter-contact surface of a further bearing-assembly component, such as, for example, a shaft or a housing. The contact can be effected radially, i.e., via outer diameter or inner diameter, but also axially, i.e., via the lateral end surfaces. Here a bearing-assembly component can be any type of component that is to be connected to a further bearing-assembly component in a positionally fixed manner or such that the bearing-assembly component and the further bearing-assembly component rotate together, and, as already mentioned, can be a component of a bearing, such as a bearing ring, a housing, a shaft, or a hub, or the like. In contrast to welding or adhesive connections, the bearing-assembly components are preferably releasably connected to each other, i.e., if needed, for example, with a possibly necessary bearing exchange, the two components can be released from each other in a non-destructive manner.

The bearing-assembly component described here is connectable in a friction-fit manner by a contact surface to a counter-contact surface of a further bearing-assembly component. Due to this friction-fit connection, the bearing-assembly component can be connected to the further bearing-assembly component in a positionally fixed manner. The two bearing-assembly components are preferably releasable from each other again when necessary.

In order to achieve this frictionally engaged, positionally fixed connection, the surface of the contact area of at least one of the components includes an embossed structure (embossment) in the material of the contact surface. Debossed regions, that is regions lowered relative to the original surrounding surface may be present as well. This embossed structure provides a mechanical roughening of the contact surface. The material of the contact surface, and in particular of the entire bearing component, is preferably comprised of metal, preferably of steel.

A steel ring could also be provided with a coating, and this coating could then be textured. In the case of a thin conversion coating such as a black oxide coating, the upset (embossed) areas would still predominantly be the steel of the base material. In the case of a thicker and more deformation-tolerant coating, the protuberances and indentations could even lie completely inside of the coating material.

In contrast to previously known methods in which additional layers such as a zinc layer or zinc lacquer or friction lacquer have been applied to the contact surface of the component, or in which the component has been roughened by sandblasting, in the present bearing-assembly component, the surface of the contact surface includes a structure embossed directly into the material of the contact surface. An additional material or layer applied onto the contact surface is not present. A mechanical roughening of the contact surface is provided by the embossed structure. This mechanical roughening therefore does not constitute an additional coating of the contact surface and is also not achieved by a removal of material, as is the case, for example, with sand blasting. Instead, the material of the surface of the contact surface is deformed by the embossed structure. Material is neither added nor removed by such a deformation, but rather a previously essentially smooth surface is transformed by material displacement into a surface with a structure. Due to the embossed structure, the contact surface thus has a higher coefficient of friction than would be the case without the embossed structure.

The embossing of such a structure has the advantage that the corresponding contact surface is completely processed mechanically, that is, the dimensions of the contact surface are already in their final state. The dimensions of the contact surface or of the corresponding bearing-assembly component do not change significantly due to the embossed structure. However, the roughness is increased by the embossed structure, since a profile, i.e., heights and depths, is generated on the finished contact surface.

Preferably only the surface of the contact area that is to come into contact with a counter-contact surface of a further component is provided with such an embossed structure. In one variant it is also possible that the entire surface of the contact surface is not provided with such a structure, but rather there are regions with embossed structure and regions without embossed structure. This has the advantage that there are also regions, in addition to the region with embossed structure, that have a precise-fit surface such as were previously manufactured by mechanical processing, for example, by grinding.

The affinity and adhesion of two surfaces, in this case the contact surface and the mating counter-contact surface, is an interplay of adhesive forces, surface energy, hardness and roughness, and roughness profile. A roughness profile with many small elevations and peaks can both interlock into a similar counter-profile and be pressed into a smooth or sufficiently soft counter-surface. It should be noted that the positionally fixed connection between the contact surface of the bearing-assembly component and the counter-contact surface is achieved by a friction fit, preferably in combination with a type of micro-interference fit. Here “friction fit” means that a retaining force with the counter-contact surface is generated purely by the contact force and the friction value of the contact surface. As already explained, the friction of the contact surface, i.e., the friction fit between the contact surface and the counter-contact surface, is improved by the embossed structure, since due to the presence of the embossed structure the contact surface has a higher coefficient of friction (also called friction value or friction coefficient) than the base material of the contact surface or of the bearing-assembly component without the embossed structure. In addition to the friction fit, however, a micro-interference fit can also be achieved by the embossed structure. This means that the generated friction fit between the contact surface of the bearing-assembly component and the counter-contact surface can at least partially be due to an interference fit on the micro-level. This micro-interference fit constitutes an actively sought toothing in the micrometer and sub-micrometer range. In the bearing-assembly component described here, this toothing of the contact surface and of the counter-contact surface at the micro-level can be actively supported by the embossed structure, or its recesses and protuberances, which can interlock with the counter-contact surface.

As mentioned above, it should be noted that the positionally fixed connection between the contact surface of the bearing-assembly component and the counter-contact surface is achieved primarily by a friction fit. Here “friction fit” means that a retaining force with the counter-contact surface is generated purely by the contact force and the friction value of the contact surface. As already explained, the friction fit is improved by the reaction layer, which has a higher coefficient of friction than the base material of the contact surface, or of the bearing-assembly component. In addition to the friction fit, however, a micro-interference fit can also be achieved by the reaction layer. This means that the generated friction fit between the contact surface of the bearing-assembly component and the counter-contact surface can at least partially comprise an interference fit at the micro-level. This micro-interference fit constitutes an actively sought interlocking in the micrometer and sub-micrometer range. In the bearing-assembly component described here, this interlocking of the contact surface and of the counter-contact surface at the micro-level can be actively supported by the soft reaction layer being able to make possible a penetrating of the counter-roughness, i.e., of the rougher counter-contact surface.

According to one embodiment, the embossed structure has impressions (or depressions) and protuberances. As already explained above, a deformation of the surface of the contact area is achieved by the embossed structure. This deformation means that the surface of the contact area is impressed at one location, and the impressed material moves away from the impression or recess and appears as protuberance around the impression. These protuberances or beads remain standing and can gain hold during the assembly in the counter-contact surface by micro-interlocking and increased local contact pressure.

The indentations are preferably distributed over the surface in such a way that not all surface elements of the surface become an indentation or elevation, but that untouched surface elements remain in between. Unlike with blasting, the average geometry of the component thereby remains completely unchanged, and a deliberate geometric fluctuation is generated only around this average and furthermore fit-precise contour.

Furthermore, there is no machining here, but rather the material is only deformed and not removed. Thus there is no particle abrasion, and no contamination arises of the bearing assembly, in particular of adjacent raceways. Unlike, for example, with sand blasting, an already correctly ground bore or other contact surface is furthermore not distorted in shape and dimension. The overlap of the interference fit remains exactly predeterminable; only the coefficient of friction is adjusted.

The embossed structure can be produced via different types of material deformation. For example, the embossed structure can be a fluting, a flanging, a knurling, a spiraling, and/or a beading. In any case, the material is only deformed by the material deformation and not removed or added.

According to a further embodiment, the embossed structure has a defined pattern. The embossed structure is preferably arranged in its orientation such that recesses and protuberances do not extend in the circumferential direction, but rather lie oblique or perpendicular to the circumferential direction. Due to such an axial extension or essentially axial extension of the structure, in particular in a rotating ring a migration can be counteracted, since the structure extends in a different direction than the rotation of the ring.

In contrast to a non-ground surface or a not completely finely ground but rather roughly ground surface, such an embossed structure has the advantage that it constitutes a defined mechanical protuberance or protuberances, i.e., the roughness the surface is to receive can be defined by the type, quantity, and orientation of the embossing. Furthermore, with a rougher grinding of the component, the surface located therein would have deep scratches that lie encircling in the circumferential direction. However, such a structure can offer no or little resistance to at least a rotating ring migration since the course of such scratches lies in the direction of the migration of the component and thus cannot counteract it.

Another aspect of the disclosure comprises a first bearing assembly component configured to be connected to a second bearing assembly component, the first bearing assembly component having a contact surface configured to frictionally engage a counter-contact surface of the second bearing assembly component to secure the first bearing assembly component to the second bearing assembly component. The contact surface includes at least one embossed structure or embossed pattern.

According to a further aspect, a method is proposed for manufacturing a bearing-assembly component as described above. The method includes the following steps: providing a bearing-assembly component with a mechanically finished contact surface, and embossing a structure on the finished contact surface in order to provide a mechanical roughening of the contact surface.

As already explained above, a mechanically finished contact surface, i.e., a contact surface that has its final operating state in its dimensions and is already finally ground, is processed in order to achieve a mechanical roughening. This roughening serves to increase the friction so that a displacing or sliding of the contact surface relative to a counter-contact surface is substantially prevented.

For this purpose, a structure is embossed on the finished contact surface. The embossing of the structure can in particular include generating impressions and protuberances. This has the advantage that no material addition or removal occurs, but rather only a deformation. For this purpose, the embossing of the structure can include a fluting, flanging, knurling, spiraling, and/or rolling of the contact surface.

For example, for a knurling, a knurling wheel can be rolled along the contact surface. Such a knurling wheel can in particular generate a contact surface roughened with small pyramid structures.

Furthermore, truing rollers for grinding wheels can be used for generating the impressions and protuberances. These have industrial diamonds or other hard materials embedded in a stable metallic or ceramic binding and can be chosen in their size as necessary. Usually such rollers are motor-driven and grind the desired shape into a grinding wheel that is also rotating but with a different circumferential speed. In order to now generate the impressions and protuberances, such a roller can be rolled on the contact surface without grinding. The result is many impressions in the material of the contact surface with their corresponding small protuberances. In contrast to a grinding method in which protuberances are removed by the grinding process, the protuberances remain with such a rolling process and then serve to connect the contact surface to the counter-contact surface in a friction-fit manner.

Apart from a rolling application, a cyclical embossing is also possible, wherein the ring is respectively moved further on the machine by a certain angle, and then while at rest a number of hard bodies, for example, diamond tips, similar to a Rockwell test, are pressed into the surface.

According to a further embodiment, the step of embossing the structure is the last mechanical processing step on the contact surface. As already explained above, this has the advantage that the dimensions and contours of the contact surface are finished in their final form, and the embossed structure is applied onto these final dimensions and contours. Preferably not only the contact surface but also the entire bearing-assembly component is finished, up to the embossed structure.

The method can furthermore include an application of a coating onto the contact surface after embossing the structure. Such a coating can be, for example, a corrosion-protection layer or other protective layer. Preferably the coating is applied so thinly that the embossed structure is not restricted in its functioning. In the case of a coating that can be deformed like the underlying structure, for example, a conversion layer, a prior coating and a subsequent introduction of the structure is likewise possible.

Preferably the mechanical final processing and the embossing of the structure can be carried out successively in the same machine. For example, the bearing-assembly component can be ground in a grinding machine, and in the same grinding machine the structure can be embossed (for example, using an embossing tool or roller tool) as final step. For this purpose, for example, a diamond roller can be used instead of a grinding wheel. Precision grinding machines or precision lathes for individual rings, e.g., large rings, have a very high stiffness and stability. The workpieces are strongly fixed and the possible tool forces are relatively high. If the number of simultaneous indentations is suitable for the hardness of the workpiece surface and is not too high, the surface roughening can therefore be carried out directly in the existing processing machine after an appropriate tool change.

In one embodiment, the embossing tool, for example, the diamond roller, is not driven (freewheeling) and simply rolls on the rotating ring with defined pressure from an elastic element, for example a disk spring pack or a hard coil spring in a horizontal guide arm. Since the dimension of the finished bearing-assembly component, e.g., of a ring, of the machine is known, and likewise the dimensioning of the roller tool, the machine can guide the tool into a position that effects a precisely defined deflection and thus contact force. During the rolling process, the contact surface, for example, a bore of a ring, becomes dull and rough. The diamond roller, or a different embossing or roller tool, can have a smaller width than the ring. This not only saves tool costs, but also increases the contact force per surface unit. With such a tool, either a plurality of encircling roughening tracks can be generated, between which untreated surface remains, or a thread-type movement can be achieved by slowly axially feeding a tool during the rolling, by which thread-type movement the entire bore (or contact surface) is rolled. Another embodiment would be to roll the entire width of the ring, but have radial recesses or a thread-like recess to limit the contact areas and keep the contact pressure per unit area high, but without requiring axial advance.

Alternatively, a roller can also be used with a plurality of large, very hard tips that press into the surface, similar to a Rockwell test, during the rolling. In this case, a roller could be used that has no diamond impregnation, but rather includes holders for individual diamonds or hard metal tips, similar to how they are installed in smoothing tools.

Further advantages and advantageous embodiments are specified in the description, the drawings, and the claims. Here in particular the combinations of features specified in the description and in the drawings are purely exemplary so that the features can also be present individually or combined in other ways.

In the following the invention is described in more detail using the exemplary embodiments depicted in the drawings. Here the exemplary embodiments and the combinations shown in the exemplary embodiments are purely exemplary and are not intended to define the scope of the invention. This scope is defined solely by the pending claims.

### BRIEF DESCRIPTION OF THE DRAWINGS

FIG. 1 is a schematic perspective view of a bearing-assembly component with a embossed structure.

FIGS. 2A-2D are schematic views of embossed structures that can be formed on a surface of the bearing-assembly component of FIG. 1.

### DETAILED DESCRIPTION

In the following, identical or functionally equivalent elements are designated by the same reference numbers.

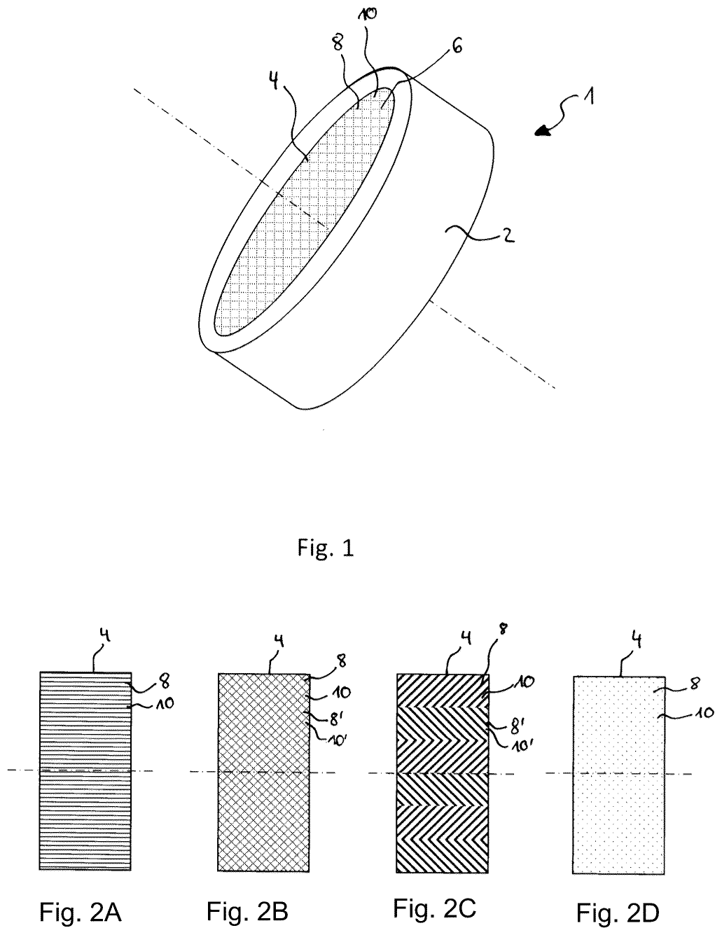

FIG. 1 shows a bearing-assembly component 1. The bearing-assembly component 1 can be a ring, as is shown here in FIG. 1, or can be any other bearing-assembly component that is to be connected in a friction-fit manner to another bearing-assembly component. For example, the bearing-assembly component can be a part of a shaft-hub connection or be a part of a rolling-element or plain bearing, such as, for example, an inner or outer ring of such a bearing.

In the following, a bearing inner ring 1 is described as a bearing-assembly component. For example, the bearing inner ring 1 can be for a tapered roller bearing or a ball bearing. However, it should be noted that the described features apply in an analogous manner for any bearing-assembly feature.

The bearing inner ring 1 includes an outer side 2 that can serve as a raceway for rolling elements or as a running surface of a plain bearing. Furthermore, the bearing inner ring 1 includes an inner bore 4 that serves as a contact surface that is to be connected in a friction-fit manner to a counter-contact surface, e.g., an outer diameter of a shaft.

For such a friction-fit connection, it is necessary that the contact surface 4 has a surface that has a sufficient friction value or friction coefficient. This can be achieved, as described below, by the contact surface 4 being partially or completely roughened.

In order to not significantly change the finished contact surface 4 in its dimensions and contours, but to nonetheless obtain a good grip between the contact surface 4 and a counter-contact surface, a structure 6, sometimes referred to as an “embossment,” is embossed in the surface of the contact surface 4. The structure 6, which by way of example is depicted here in the form of intersecting stripes extending in two different directions obliquely with respect to the circumferential direction, mechanically roughens the surface of the contact surface 4, without, however, removing or adding material. Rather, the material of the contact surface 4 is only deformed and forms recesses or depressions or impressions 8 and protuberances 10. The structure 6 thus increases the friction value of the contact surface 4.

The protuberances 10 arise by the material of the contact surface 4 being processed with an embossing tool or a roller tool in order to generate the impressions 8. In the impressions 8, the material is on the one hand compressed and on the other hand moved away, so that the protuberances 10 arise.

The protuberances 10 protrude here in comparison to the impressions 8 and can interlock with the counter-contact surface when the bearing inner ring 1 is installed on the shaft. In addition, the local contact pressure of a protuberance is increased. If the bearing material is harder than the shaft material, the shaft material can be impressed locally by the protuberance. The friction-fit and partial interference-fit connection of the bearing inner ring 1 to the shaft is thus improved by the protuberances 10.

However, since the material of the contact surface 4 is only deformed, the basic contour and the dimensions of the bearing inner ring 1 remain essentially present, so that in this respect no further post-processing of the bearing inner ring 1 is required. Optionally a coating, such as, for example, a corrosion-protection layer, can also be applied onto the contact surface of the bearing inner ring after embossing of the structure 6.

The embossed structure 6 preferably shows a defined pattern, as is depicted by way of example in FIGS. 2A to 2D. In order to avoid a migration of the bearing inner ring 1 in the circumferential direction, the embossings 8 and protuberances 10 in FIGS. 2A, 2B, and 2C are not aligned in the circumferential direction. In FIG. 2A, the embossings 8 and protuberances 10 extend in the axial direction.

In order to additionally also prevent a migration or displacement of the bearing inner ring 1 in the axial direction, the embossings 8 and protuberances 10 can also extend in an oblique direction, that is, obliquely with respect to both the circumferential direction and the axial direction. In such obliquely extending structures, it is useful to keep the number and shaping of structures extending to the side balanced in both directions so that there can be no tendency of the ring to move sideways in a thread-like manner. Here embossed lines 8, 8′, and the associated protuberances 10, 10′, can either cross with the formation of roughness patterns (see FIG. 2B), or alternatively a number of oblique lines 8 with associated protuberances 10 can be disposed axially rightward, and an equal number of oblique lines 8′ with associated protuberances 10′ can be disposed axially leftward at a mirror-image angle, as is depicted in FIG. 2C. A purely one-sided thread-type structure could lead to an axial movement if the system nevertheless starts to move.

Alternatively, the embossings 8 and protuberances 10 can also not form stripes or grooves, but rather the embossings 8 can be point-shaped and the protuberances 10 correspondingly pyramid-shaped between the point-shaped protuberances 10, as is depicted in FIG. 2D.

It should be noted that although in the Figures the contact surface 4 is completely provided with the structure 6, the structure 6 can also be applied only in partial regions.

In summary, due to the bearing-assembly component described here, an easy-to-manufacture and cost-effective possibility is provided to improve the friction-fit connection between two bearing-assembly components.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved bearing assembly components and method of assembling the components.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### REFERENCE NUMBER LIST

1 Bearing-assembly component
2 Outer side
4 Inner bore/contact surface
6 Embossed structure
8, 8′ Embossings
10, 10′ Protuberances

What is claimed is:

1. A first bearing assembly component configured to be connected to a second bearing assembly component, the first bearing assembly component having a contact surface configured to frictionally engage a counter-contact surface of the second bearing assembly component to secure the first bearing assembly component to the second bearing assembly component,
wherein the contact surface includes at least one embossed structure.

2. The first bearing assembly component according to claim 1,
wherein the at least one embossed structure comprises an embossed pattern.

3. The first bearing assembly to claim 1,
wherein the at least one embossed structure includes depressions and protuberances.

4. The first bearing assembly component according to claim 1,
wherein at least one embossed structure is selected from a group consisting of: a fluting, a flanging, a knurling, a spiraling, a beading, and point-shaped recesses.

5. The first bearing assembly component according to claim 1,
wherein the at least one embossed structure comprises an embossed pattern having linear portions extending in an axial direction.

6. The first bearing assembly component according to claim 1,
wherein the at least one embossed structure comprises an embossed pattern having linear portions extending obliquely to a circumferential direction of the first bearing assembly component and to an axial direction of the first bearing assembly component.

7. The first bearing assembly component according to claim 1,
wherein the embossed structure comprises a zig-zag pattern.

8. The first bearing assembly component according to claim 1,
wherein the contact surface is mechanically finished.

9. A bearing assembly comprising:
a first bearing assembly component according to claim 1; and
the second bearing assembly component connected to the first bearing component with the contact surface in contact with the counter-contact surface.

10. The bearing assembly according to claim 9,
wherein the first bearing component comprises a bearing inner ring, and
wherein the contact surface is a radially inner surface of the bearing inner ring.

11. A method comprising:
providing a first bearing assembly component having a mechanically finished contact surface configured to be connected in a friction fit manner to a second bearing component having a counter-contact surface, and
embossing at least one structure on the contact surface.

12. The method according to claim 11,
wherein the embossing comprises generating impressions and protuberances in the contact surface.

13. The method according to claim 11,
wherein the embossing comprises fluting, flanging or knurling the contact surface.

14. The method according to claim 11,
wherein the embossing comprises forming flanges.

15. The method according to claim 14,
including debossing point-like recesses in the contact surface.

16. The method according to claim 11,
including mounting the first bearing component to the second bearing component in a friction fit manner with the contact surface in contact with the counter-contact surface,
wherein the embossing is a final mechanical processing step before the mounting.

17. The method according to claim 11,
including applying a coating to the contact surface after the embossing.

18. The method according to claim 15,
wherein the mechanical processing step and the embossing are performed while the first bearing component is held by a same machine.
